(19) United States
(12) Patent Application Publication
(10) Pub. No.: US 2017/0182507 A1
(43) Pub. Date: Jun. 29, 2017

(54) CONTACTING TYPE INFILTRATION GROOVE FOR PHOTORESIST COATING EQUIPMENT

(71) Applicant: Shenahen China Star Optoelectronics Technology Co., Ltd., Shenzhen, Guangdong (CN)

(72) Inventor: Hui CHEN, Shenzhen, Guangdong (CN)

(21) Appl. No.: 14/008,088

(22) PCT Filed: Jun. 29, 2013
(86) PCT No.: PCT/CN13/78498

§ 371 Date: Sep. 27, 2013

(30) Foreign Application Priority Data
May 10, 2013 (CN) 201310173578.2

(51) Int. Cl. B05B 15/00; B05B 15/06; B05B 15/02

(52) U.S. Cl. CPC B05B 15/001; B05B 15/02; B05B 15/065

(57) ABSTRACT

The present invention provides a contacting type infiltration groove for photoresist coating equipment, comprises a loading main body and a sprinkler head. A spray nozzle is provided at the end of the sprinkler head, wherein, a limiting component is additional clamped at the end of the sprinkler head to make only the spray nozzle of the sprinkler head dip into the solvent in the loading main body. The sprinkler head can be hold up by the limiting component to separate the non-spray nozzle from the solvent so as to avoid the solvent contacting on the surface of the non-spray nozzle part. The contacting surface of the sprinkler head is setting on the top of the spray nozzle to make them adhere seamlessly together.

### FIELD OF THE INVENTION

The present invention is related to an infiltration groove, and more particularly relates to a contracting type infiltration groove to reduce the contacting area of the sprinkler head in the solvent.

### BACKGROUND OF THE INVENTION

The conventional infiltration groove is provided for containing chemical solvent for dipping into the sprinkler head of the photoresist coating if it do not work in the long time, to prevent the photoresist volatilizing and drying to cause poor coating. But the volume of the present infiltration groove is so large to contain a large number of solvent. The solvent remain on the sprinkler head can not easy to wipe off, so cause the sprinkler head corrode in a large area to influence the coating effect. When the solvent is imported into the infiltration groove, the liquid lever is hard to control and instability, so it is difficult to accurately control the contact area and range of the sprinkler head in the solvent.

### SUMMARY OF THE INVENTION

According to the disadvantages of the prior art, the major purpose of the present invention is provided for a contacting type infiltration groove to effectively control the contacting area of the sprinkler head in the solvent and avoid a large amount of solvent remaining on the sprinkler head.

The present invention provides a contacting type infiltration groove for photoresist coating equipment, comprises a loading main body and a sprinkler head. A spray nozzle is provided at the end of the sprinkler head, wherein, a limiting component is additional clamped at the end of the sprinkler head to make only the spray nozzle of the sprinkler head dip into the solvent in the loading main body. The sprinkler head can be hold up by the limiting component to separate the non-spray nozzle from the solvent so as to avoid the solvent contacting on the surface of the non-spray nozzle part.

Preferably, the contacting surface between the limiting component and the sprinkler head is setting on the top of the spray nozzle to make them seamlessly adhere to each other. The limiting component comprises a left-limiting component and a right-limiting component respectively, which standing on the loading main body. The opposite sides of the left-limiting component and the right-limiting component are provided for a slant face matching to the sprinkler head. The bottoms of the left-limiting component and the right-limiting component are spaced by the sprinkler head to form a solvent container, the spray nozzle is dipping into the solvent of the solvent container. The limiting component is provided for supporting the sprinkler head and insulating the non-spray nozzle part from the solvent.

Preferably, the distance between the left-limiting component and the right-limiting component is larger than the minimum width of the spray nozzle. The proportion of the spray nozzle dipped in the solvent in the whole spray nozzle 20 is below 1/10, e.g. the volume of the spray nozzle dipping into the solvent is about 1-2 mm.

Preferably, a horizontal adjusting device is provided for adjusting the relative horizontal position between the loading main body and the sprinkler head and making the limiting component and the sprinkler head adhere together more closely, which is located at the outside of the two walls of the loading main body. A vertical adjusting device is provided for adjusting the relative vertical position between the limiting component and the sprinkler head to make them adhere together more closely. The horizontal adjusting device and the vertical adjusting device can be selected of spring. The relative position between the loading main body and the sprinkler head can be adjusted by the horizontal adjusting device and the vertical adjusting device to make the sprinkler head adhere to the limiting component more closely, and ensure the compaction of them.

Preferably, a plurality of liquid supplying holes are opening on the top of the loading main body, a waste liquid discharging hole is opening on the bottom of the loading main body. The liquid supplying holes are provided for three holes which are uniformly-spaced located at the two sides and the middle of the loading main body respectively to supply the solvent into the loading main body from the difference positions. The rate of flow and the velocity of flow can be controlled by supplying liquid from different positions to cause the liquid surface to be steadily on the supplying process.

The present invention also provided for a contacting type infiltration groove for containing the solvent of the photoresist coating, which comprising a loading main body and a sprinkler head, a spray nozzle is provided at the end of the sprinkler head, wherein, a limiting component is additional clamped at the end of the sprinkler head to make only the spray nozzle of the sprinkler head dip into the solvent in the loading main body.

Compared to the prior art, the contacting type infiltration groove for containing the solvent of the photoresist coating of the present invention additional comprises a limiting component standing in the loading main body. The sprinkler head can be hold up by the limiting component to make only the spray nozzle of the sprinkler head dip into the solvent in the loading main body, avoid the solvent contacting on the surface of the non-spray nozzle part, and reduce the contact surface of the sprinkler head in the solvent. Additional, the horizontal adjusting device and the vertical adjusting device are located at the outer wall and the bottom of the loading main body for respectively adjusting the horizontal and vertical relative position between the loading main body and the sprinkler head, so as to make the limiting component adhere to the sprinkler head more closely and avoid the solvent contacting on the non-spray nozzle part. Besides that, a plurality of liquid supplying holes are provided for supplying liquid into the loading main body with a small and steadily flow.

### DESCRIPTIONS OF THE DRAWINGS

FIG. 1 is a schematic perspective view of the contacting type infiltration groove for containing the solvent of the photoresist coating according to the prior art;

FIG. 2 is a side view of the contacting type infiltration groove for containing the solvent of the photoresist coating according to the prior art;

FIG. 3 is a schematic perspective view of the contacting type infiltration groove for containing the solvent of the photoresist coating according to the present invention;

FIG. 4 is a vertical view of the contacting type infiltration groove for containing the solvent of the photoresist coating according to the present invention;

FIG. 5 is a side view of the loading main body of the contacting type infiltration groove for containing the solvent of the photoresist coating according to the present invention; and

FIG. 6 is a vertical view of the loading main body of the loading main body of the contacting type infiltration groove for containing the solvent of the photoresist coating according to the present invention.

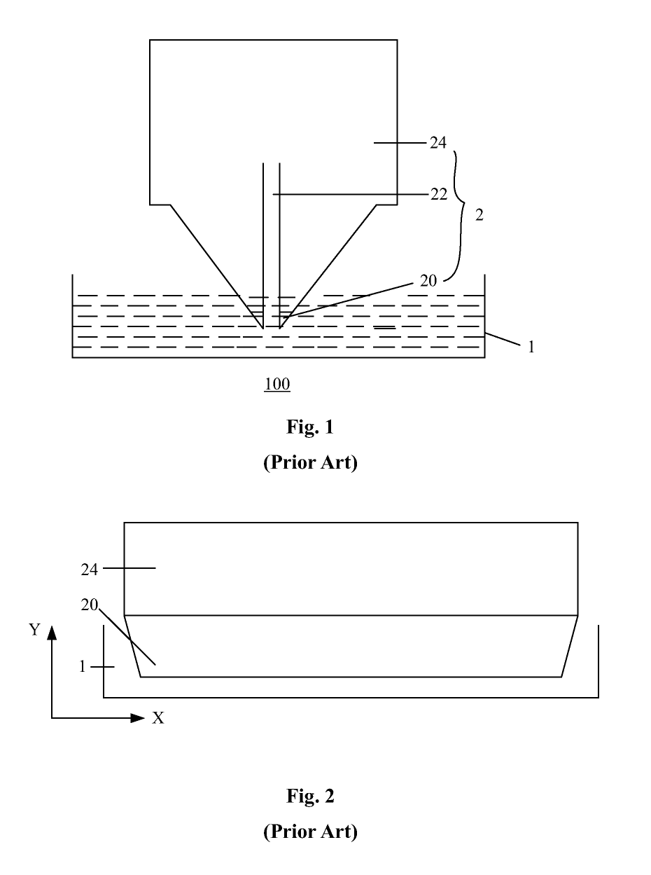

### DETAILED DESCRIPTIONS OF THE PREFERRED EMBODIMENTS

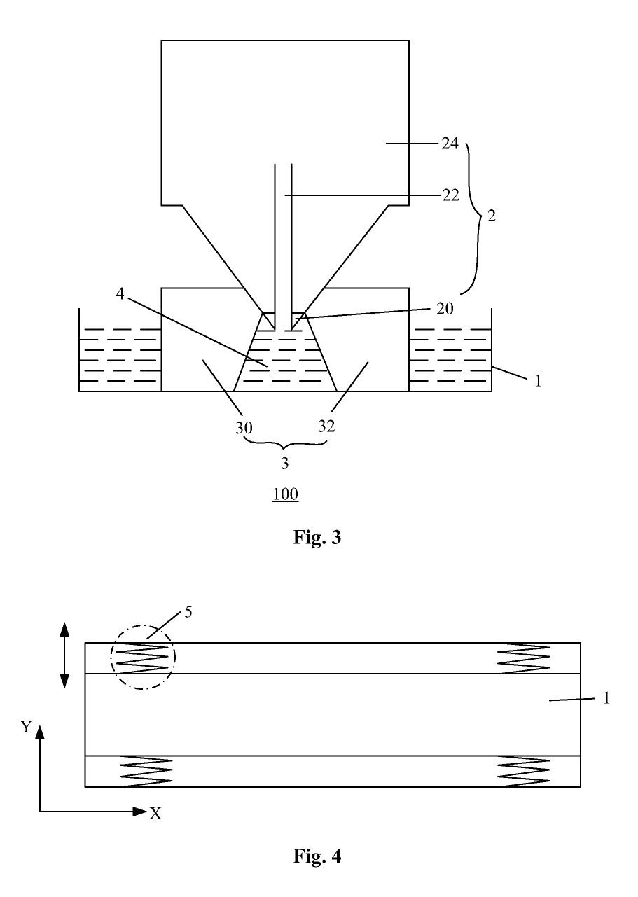

Refer to FIG. 3, the present invention provides a contacting type infiltration groove for containing the solvent of the photoresist coating 100 comprising a loading main body 1 and a sprinkler head 2. A spray nozzle 20 is located at the end of the sprinkler head 2, wherein, a limiting component 3 is additional clamped at the end of the sprinkler head 2 to make only the spray nozzle 20 of the sprinkler head 2 dip into the solvent in the loading main body 1.

The loading main body 1 is a oblong groove for retaining the chemical solvent for coating. The sprinkler head 2 is vertically standing on the loading main body 1 and extending along the X-axis of the loading main body 1. The length of the sprinkler head 2 is less than that of the loading main body 1. The sprinkler head 2 comprises a spray nozzle 20, a photoresist snore piece 22 and a suction chamber 24, the spray nozzle 20 is assembled below the suction chamber 24. The spray nozzle 20 is a cone-shape structure. The spray nozzle 20 and the sprinkler head 2 can be an integrated molding structure or a separated structure. Liquid supplying holes 202 are opening on the bottom of the spray nozzle 20. The photoresist snore piece 22 is inserted into the inner cavity of the spray nozzle 20 from the liquid supplying hole 202 of the spray nozzle 20. The chemical solvent can be extracted from the loading main body 1 through the liquid supplying holes 202 and attracted into the suction chamber 24 through the spray nozzle 20. The photoresist snore piece 22 is seamlessly jointed with the liquid supplying holes 202 to keep good gas tightness during attracting.

The limiting component 3 comprises a left-limiting component 30 and a right-limiting component 32 separately, which are standing on the loading main body 1. The opposite sides of the left-limiting component 30 and the right-limiting component 32 are provided for a slant face matching to the sprinkler head 2. The bottoms of the left-limiting component 30 and the right-limiting component 32 are spaced by the sprinkler head to form a solvent container 4, the spray nozzle 20 is dipping into the solvent of the solvent container 4. The contacting surface of the sprinkler head 2 is setting on the top of the spray nozzle 20 to make them seamlessly adhere to each other. The distance between the left-limiting component 30 and the right-limiting component 32 is larger than the minimum width of the spray nozzle 20. The left-limiting component 30 is standing on the left side of the sprinkler head 2. The slant surface for adhering to the sprinkler head 2 is formed at the right side of the sprinkler head 2. The right-limiting component 32 is standing on the right side of the sprinkler head 2. The slant surface for adhering to the sprinkler head 2 is formed at the left side of the sprinkler head 2. The spray nozzle 20 is clamped and hold up by the two limiting components 3. The two limiting components 3 are extending along the X-axis of the loading main body 1. A gap is provided at the two limiting components 3. When two limiting components are adhered to the sprinkler head 2 closely, the bottoms of two limiting components is surrounded the spray nozzle 20 to form a solvent container 4. In the present embodiment, the solvent container 4 is a ladder-shaped groove. The spray nozzle 20 is dip into the solvent contained in the solvent container 4. The solvent can be extracted from the spray nozzle 20 and attracted into the suction chamber 24 from the photoresist snore piece 22. The proportion of the spray nozzle dipped in the solvent in the whole spray nozzle 20 is below 1/10. The sprinkler head 2 can be hold up by the limiting component to insulate the non-spray nozzle part from the solvent and avoid the solvent contacting and remaining on the surface of the sprinkler head 2 to be corroded. And the contacting area and range of the spray nozzle 20 in the solvent can be accurately controlled. The material of the limiting component can be selected from the PERFLUO Elastomer or EPDN and so on, which is elastic material with resistance to corrosion.

In the present invention, the shape of the contacting surface between the limiting component 3 and the sprinkler head 2 will be not limited. As long as the limiting component can be adhered to the sprinkler head 2 closely. In the same way, the shape of the solvent containing 4 also will be not limited.

Refer to FIG. 4, for automatic adjusting the horizontal respective position between the loading main body 1 and the sprinkler head 2, a horizontal adjusting device 5 is provided for adjusting the relative horizontal position between the loading main body 1 and the sprinkler head 2. The horizontal adjusting devices 5 are two couples which are respectively located at the outside of the two walls of the loading main body 1. On assembling, putting the loading main body 1 into the assembling space, then the horizontal adjusting devices 5 can be resisted to the inner side-wall of the assembling space. The horizontal adjusting device 5 can be selected from the spring. The loading main body 1 can active freely. The horizontal position between the horizontal adjusting device 5 and the loading main body 1 can be micro-adjusted so as to ensure the limiting component 3 closely adhere to the sprinkler head 2 in the horizontal direction (X-axis) and keep good gas tightness by the elastic restoring force of the spring. The horizontal adjusting devices 5 are two couples for synchronous adjusting or respectively adjusting at the two sides depend on the position of the loading main body.

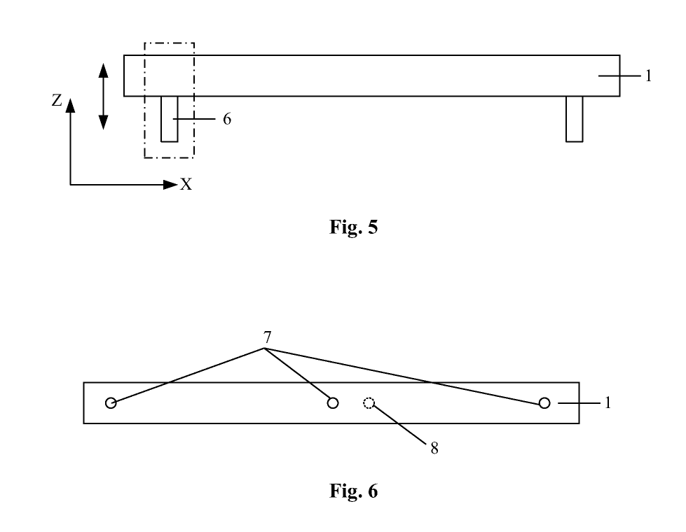

Refer to FIG. 5, for automatic adjusting the vertical respective position between the loading main body 1 and the sprinkler head 2, a vertical adjusting device 6 is provided for adjusting the relative vertical position between the loading main body 1 and the sprinkler head 2 and making the limiting component 3 and the sprinkler head 2 adhere together more closely, which is located at the bottom of the loading main body 1. Similarly, the vertical adjusting devices 6 are two couples which are respectively located at the two sides of the bottom of the loading main body 1. The vertical adjusting device 6 can be selected from the spring. The vertical position between the vertical adjusting device 6 and the loading main body 1 can be micro-adjusted so as to ensure the limiting component 3 closely adhere to the sprinkler head 2 in the vertical direction (Z-axis) and keep good gas tightness by the elastic restoring force of the spring. Therefore, the horizontal and the vertical respective position between the loading main body 1 and the sprinkler head 2 can be adjusted on X-axis and Z-axis with the horizontal adjusting device 5 and the vertical adjusting device 6 for keeping the limiting component 3 and the sprinkler head 2 seamlessly adhering together more closely and prevent the solvent containing and remaining on the outside surface of the non-spray nozzle part.

Refer to FIG. 6, a plurality of liquid supplying holes 7 are opening on the top of the loading main body 1, a waste liquid discharging hole 8 is opening on the bottom of the loading main body 1. In the present embodiment, the liquid supplying holes 7 are provided for three holes, and the waste liquid discharging hole 8 is provided for one hole. Before dipping, the solvent is imported into the loading main body 1 through the three liquid supplying holes 7. The fluctuating and instability problem on supplying liquid can be solved by averagely imported through three liquid supplying holes. Because of the volume of the loading main body 1 is small, the flow of the liquid supplying through three liquid supplying holes will be also small to make the liquid surface balance. If the height of the supplying liquid is exceeded to that of the loading main body, then the solvent will be automatic overflowing for prevent the liquid level of the loading main body overtop.

What is claimed is:

1. A contacting type infiltration groove for photoresist coating equipment, provided for containing the solvent of the photoresist coating, comprising a loading main body and a sprinkler head, a spray nozzle is provided at the end of the sprinkler head, wherein, a limiting component is additional clamped at the end of the sprinkler head, the contacting surface of the sprinkler head is setting on the top of the spray nozzle to make only the spray nozzle of the sprinkler head dip into the solvent in the loading main body.

2. The contacting type infiltration groove for photoresist coating equipment according to claim 1, wherein, the limiting component comprises a left-limiting component and a right-limiting component are adhering seamlessly to the sprinkler head respectively, which standing on the loading main body.

3. The contacting type infiltration groove for photoresist coating equipment according to claim 2, wherein, the opposite sides of the left-limiting component and the right-limiting component are provided for a slant face matching to the sprinkler head.

4. The contacting type infiltration groove for photoresist coating equipment according to claim 3, wherein, the bottoms of the left-limiting component and the right-limiting component are spaced by the sprinkler head to form a solvent container, the spray nozzle is dipping into the solvent of the solvent container.

5. The contacting type infiltration groove for photoresist coating equipment according to claim 4, wherein, the distance between the left-limiting component and the right-limiting component is larger than the minimum width of the spray nozzle.

6. The contacting type infiltration groove for photoresist coating equipment according to claim 5, wherein, the proportion of the spray nozzle dipped in the solvent in the whole spray nozzle 20 is below 1/10.

7. The contacting type infiltration groove for photoresist coating equipment according to claim 2, wherein, a horizontal adjusting device is provided for adjusting the relative horizontal position between the loading main body and the sprinkler head and making the limiting component and the sprinkler head adhere together more closely, which is located at the outside of the two walls of the loading main body.

8. The contacting type infiltration groove for photoresist coating equipment according to claim 2, wherein, a vertical adjusting device is provided for adjusting the relative vertical position between the limiting component and the sprinkler head to make them adhere together more closely.

9. The contacting type infiltration groove for photoresist coating equipment according to claim 7, wherein, the horizontal adjusting devices are two couples, which are respectively located at the outside of the two walls of the loading main body symmetrically.

10. The contacting type infiltration groove for photoresist coating equipment according to claim 8, wherein, the vertical adjusting devices are two couples, which are respectively located at the two sides of the bottom of the loading main body symmetrically.

11. The contacting type infiltration groove for photoresist coating equipment according to claim 7, wherein, the horizontal adjusting device can be selected of spring.

12. The contacting type infiltration groove for photoresist coating equipment according to claim 8, wherein, the vertical adjusting device can be selected of spring.

13. The contacting type infiltration groove for photoresist coating equipment according to claim 3, wherein, a plurality of liquid supplying holes are opening on the top of the loading main body, a waste liquid discharging hole is opening on the bottom of the loading main body.

14. The contacting type infiltration groove for photoresist coating equipment according to claim 13, wherein, the liquid supplying holes are provided for three holes which are uniformly-spaced located at the two sides and the middle of the loading main body respectively to supply the solvent into the loading main body from the difference positions.

15. The contacting type infiltration groove for photoresist coating equipment according to claim 2, wherein, the material of the limiting component can be selected from the PERFLUO Elastomer or EPDN.

16. A contacting type infiltration groove for photoresist coating equipment, comprising a loading main body and a sprinkler head, a spray nozzle located at the end of the sprinkler head, wherein, a limiting component is additional clamped at the end of the sprinkler head to make only the spray nozzle of the sprinkler head dip into the solvent in the loading main body.

17. The contacting type infiltration groove for photoresist coating equipment according to claim 16, wherein, the contacting surface of the sprinkler head is setting on the top of the spray nozzle to make them respectively adhere seamlessly together.

18. The contacting type infiltration groove for photoresist coating equipment according to claim 17, wherein, the limiting component comprises a left-limiting component and a right-limiting component are respectively standing on the loading main body, the opposite sides of the left-limiting component and the right-limiting component are provided for a slant face matching to the sprinkler head, the bottoms of the left-limiting component and the right-limiting component are spaced by the sprinkler head to form a solvent container, the spray nozzle is dipping into the solvent of the solvent container.

19. The contacting type infiltration groove for photoresist coating equipment according to claim 17, wherein, a horizontal adjusting device is provided for adjusting the relative horizontal position between the loading main body and the sprinkler head and making the limiting component and the sprinkler head adhere together more closely, which is located at the outside of the two walls of the loading main body.

20. The contacting type infiltration groove for photoresist coating equipment according to claim 17, wherein, a vertical adjusting device is provided for adjusting the relative vertical position between the limiting component and the sprinkler head and making them adhere together more closely.
